(19) United States
(12) Patent Application Publication
(10) Pub. No.: US 2007/0039089 A1
(43) Pub. Date: Feb. 22, 2007

(54) Noise and splash attenuation agent and device

(76) Inventor: Keith A. Worrel, Olathe, KS (US)

Correspondence Address: CHASE LAW FIRM L.C, 4400 COLLEGE BOULEVARD, SUITE 130, OVERLAND PARK, KS, 66211, US

(21) Appl. No.: 11/506,511

(22) Filed: Aug. 18, 2006

Related U.S. Application Data
(60) Provisional application No. 60/709,669, filed on Aug. 19, 2005.

(51) Int. Cl. E03D 9/00; F15D 1/00

(52) U.S. Cl. 4/300.3

(57) ABSTRACT

A noise and splash attenuation device for use in a standard toilet fixture with a liquid filled bowl, receiving falling debris along a generally vertical axis comprises a generally planar sheet having a transmission network for transmitting the debris to the liquid surface through the sheet. An incident angle is presented by the sheet in relation to the vertical axis of the falling liquid at the impact of the falling liquid on the sheet. An alternative embodiment of a foam producing agent formed as a result of a reaction between a surfactant, an alkaline metal carbonate, an organic acid and the liquid contained within the toilet fixture where the produced foam substantially covers the liquid surface. Another alternative embodiment may include placing a generally planar sheet within the toilet fixture, the foam producing agent applied to the planar sheet for reaction with the liquid surface. Another alternative embodiment may include elongated structures positioned within the toilet fixture, providing a transmission network for transmitting the falling liquid to the liquid surface through the elongated structures for attenuating the noise and splash emitted from any falling debris upon contact with the liquid surface.

### CROSS REFERENCE TO RELATED APPLICATION

This application claims the benefit of U.S. non-provisional application No. 60/709,669 filed Aug. 19, 2005 which is incorporated herein by reference.

### FIELD OF THE INVENTION

This invention is directed to a plumbing fixture accessory and more particularly, to anti-splatter and sanitary agent or device adapted for receipt within a commercial or residential toilet with standing water.

### BACKGROUND OF THE INVENTION

Noise emitted from a plumbing fixture during use can travel outside a water closet area and into non-private areas for observation by others. This noise can be embarrassing and interrupt others during conversation or other activities. In addition to the noise emitting from the plumbing fixture, liquids may be ejected from the fixtures as a result of falling liquid impacting the surface of a standing liquid which may be contained within the fixture, such as within a bowl. Such ejected liquid may contaminate the environment surrounding the plumbing fixture, creating an unsanitary condition with the possible risk of spreading diseases, or possibly creating a slippery environment with the possibility of injury to others.

What is needed is an improved agent or article which reduces the emitted noise and the ejected liquid from the plumbing fixture.

### SUMMARY OF THE INVENTION

The present invention provides a noise and splash attenuating device or agent for use in a standard toilet fixture with a liquid filled bowl for receiving liquid falling along a generally vertical axis. The device may consist of a sheet adapted for resting on the liquid surface at a zone of contact between the falling liquid and the liquid surface, where the sheet includes a transmission network for transmitting the falling liquid to the liquid surface through the sheet. In addition, the sheet provides an incident angle formed in relation to the vertical axis of the falling liquid at the sheet where the falling liquid is received by the sheet. The agent may include foam formed from reacting a surfactant, an alkaline metal carbonate and an organic acid with the liquid within the bowl where the foam substantially covers the liquid surface. The agent may be used independent from or in combination with the device described above.

In accordance with another embodiment of the present invention, a noise and splash attenuation device is provided which receives the falling liquid and reduces the momentum of the falling liquid.

### BRIEF DESCRIPTION OF THE DRAWINGS

The drawings constitute a part of this invention and include exemplary embodiments of the present invention and illustrate various objects and features thereof.

FIG. 1 is a top plan view of the present invention located within a bowl of a standard plumbing fixture.

FIG. 2 is a top plan view of the invention;

FIG. 3 is a partial top view of the invention superimposed over the perimeter of standing water contained within the plumbing fixture.

FIG. 4 is a side view of an alternative embodiment of the present invention.

FIG. 5A is a top perspective view of an alternative embodiment of the present invention.

FIG. 5B is an elevational perspective view of an alternative embodiment of the present invention.

FIG. 6A is a side view of an alternative embodiment of the present invention attached to a wall.

FIG. 6B is a front perspective view of an alternative embodiment of the present invention.

FIG. 7A is a top plan view of an alternative embodiment of the present invention.

FIG. 7B is an elevational perspective view of an alternative embodiment of the present invention.

FIG. 8 is a perspective view of an alternative embodiment of the present invention with a plurality of elongated anti-splatter structures.

FIG. 9 is a cross-sectional view of the plumbing fixture in accordance with the alternative embodiment of FIG. 8.

FIG. 10 is a plan view of a foam within the plumbing fixture formed from a foam agent in accordance with an alternative embodiment of the present invention.

FIG. 11 is a cross-sectional view of the plumbing fixture in accordance with the alternative embodiment of FIG. 10.

FIG. 12 is an illustration of a distribution system in accordance with an alternative aspect of the alternative embodiment of FIG. 10.

### DETAILED DESCRIPTION

I. Introduction

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

II. Noise and Splash Attenuation Device

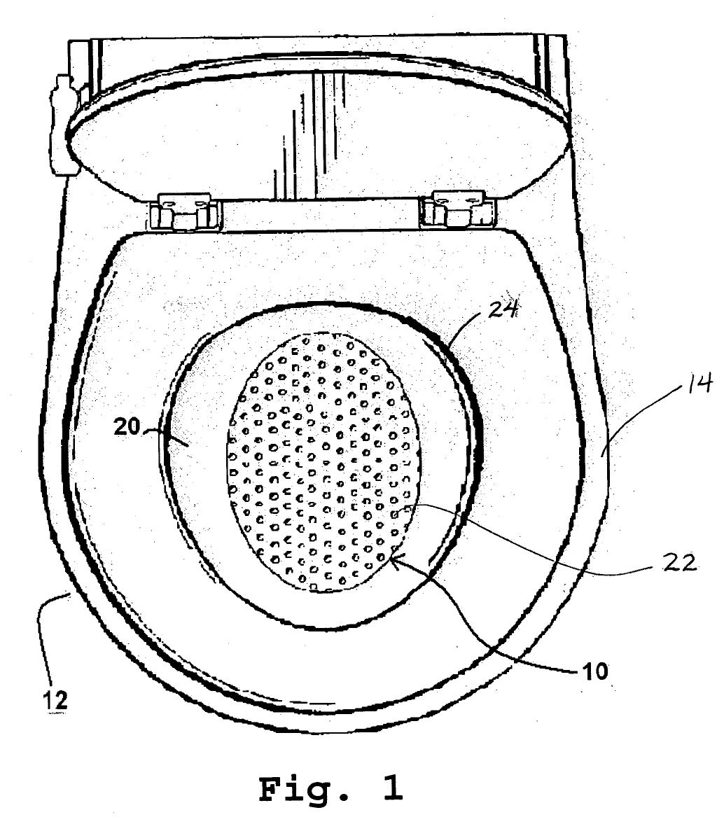

Referring now to the drawings in general and FIG. 1 in particular, a noise and splash attenuating device 10 is shown located within a standard toilet fixture 12 also referred to herein as a plumbing fixture. Fixture 12 preferably has standard dimensions and includes a collection basin or bowl 14 adapted for being at least partially filled with water having a liquid surface 20 and for receiving a falling debris such as liquid or solid waste (not shown) 50 traveling generally along a vertical axis (not shown). Alternatively the fixture may also be a urinal or another non-standard plumbing fixture with adapted to receive falling debris. In general, the device 10 is adapted for placement within the interior of the bowl 14.

Device 10 is preferably a sheet fabricated from a cellulous material such as but not limited to wood pulp or paper having a density generally less than water, adapted for resting on or slightly below the liquid surface 20 contained within the bowl 14. Optionally, the cellulous material may be provided having a transmission network 22 for transporting a falling liquid 50 from one location and diffusing it throughout the fixture 12 or to a specific location, it being known by one skilled in the art that various materials have an ability to diffuse or transport liquids for example through diffusion or capillary action. As further illustrated in FIG. 2 the device 10 may be configured to provide a substantially solid planar surface 22a optionally having a plurality of apertures 22b which are part of the transmission network 22. The solid planar surface 22a is elevated or depressed depending on an applied force. In addition, the liquid transmitted may elevate through the transmission network to the sides of the device 10 along the central region of the device 10 providing a deflected surface for impact with the falling liquid 50.

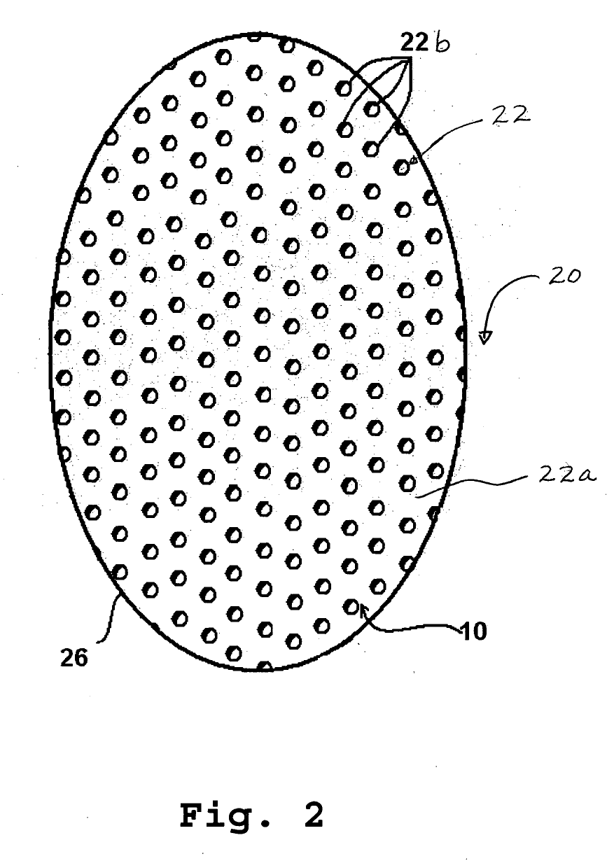

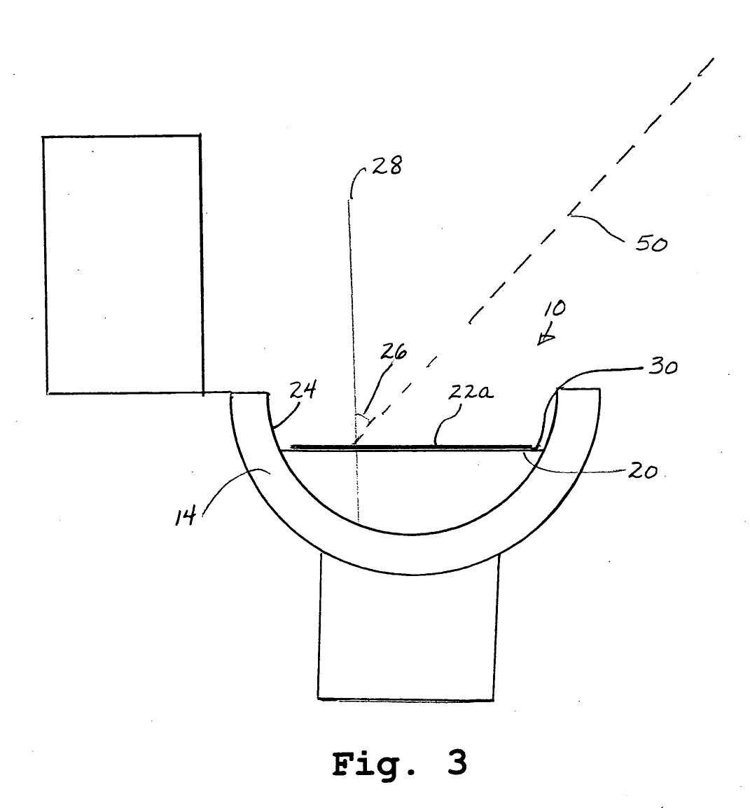

The device 10, is shown overlying the liquid surface 20 in FIG. 3. The planar surface 22a provides a barrier between the liquid surface 20 while the optional apertures 22b provide a channel between the planar surface 22a and the liquid surface 20. As illustrated, the apertures 22b are circular; however, other configurations are possible which provide for the transmission of falling liquid 50 from the planar surface 22a to the liquid surface 20.

As indicated in FIG. 3, the planar surface 22a is preferably located in association with a zone of contact 30 located between the liquid surface 20 and the falling liquid 50. A bowl surface 24, is generally located along the interior of the bowl 14 and is adapted to receive the liquid surface 20. Preferably, the device 10 is positioned within the bowl surface 24, the planar surface 22a extending upwardly from the liquid surface 20, with the device 10 being preferably suspended on the liquid surface 20. In addition, the transmission network may include baffles distributed throughout the planar surface 22a for suspending the device 10 on the liquid surface 20.

The device 10 may alternatively be configured with a circular, oval or polygonal perimeter or with an irregular shape. In addition, the device 10 may also be adapted for receiving printed indicia on the planar surface 22a for enhancing the visual appearance of the device 10. An alternative embodiment of the present invention may utilize one or more layers or plural devices 10 vertically arranged to provide additional noise and splash attenuation of the falling liquid 50.

As illustrated in FIG. 3 the device 10 is positioned within the bowl 14 and presents an incident angle 26 formed in relation to the vertical axis 28 of the device 10 at the intersection of the device 10 and the falling liquid 50. Although, the illustrated vertical axis 28 is generally aligned with the fixture's 12 vertical axis (not shown) the vertical axis 28 may vary depending on the device's planar surface 20a. For example, the planar surface may form indentations at the optional apertures 22b or may be elevated at the optional baffles. In which case, the vertical axis 28 may vary at the approach of the aperture 22b. The vertical axis 28 is generally determined where the falling liquid 50 is received.

In operation, and referring again to FIG. 3, a user (not shown) will place the device 10 within the fixture 12 allowing the device 10 to float on the liquid surface 20. Upon receipt of a fallen liquid 50, the momentum of the falling liquid 50 is partially transferred to the device 10. The device 10 suspended on the liquid surface 20, forms an incident angle 26 with the falling liquid 50. After receipt by the device 10 of the falling liquid 50, the transmission network 22 (not shown) transmits the falling liquid 50 to the liquid surface 20. By reducing the momentum of the falling liquid 50, the resultant noise and splash are also reduced resulting in an attenuation of the noise and the splash associated with the falling liquid 50. The device 10 is preferably designed to remain suspended on the liquid surface 20 for approximately 20 to 40 seconds.

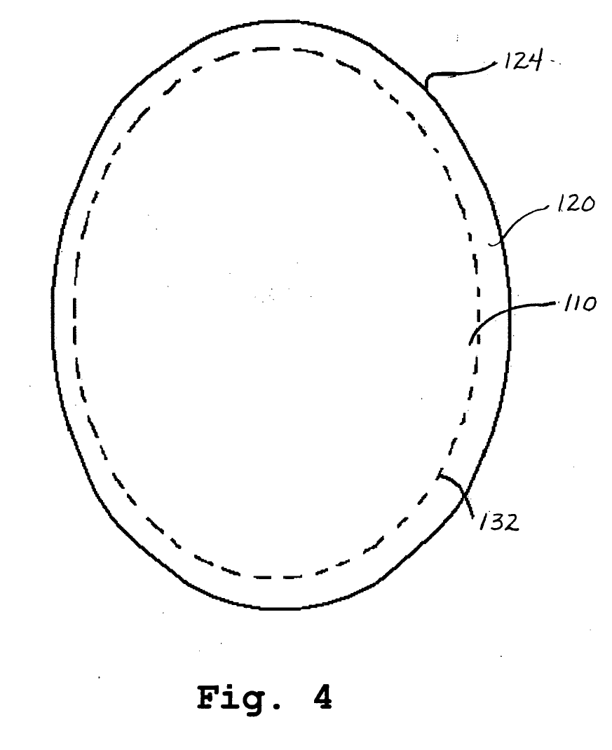

In an alternative embodiment, a perimeter 132 of a device 110 is recessed as illustrated in FIG. 4 from a bowl surface 124 located along the interior of a fixture 112 (not shown). The reduced radius device 110 continues to substantially cover a liquid surface 120. This embodiment may provide economic benefits while the device 110 continues to engage a liquid surface 120 for attenuating the splash and noise of the falling liquid 150 (not shown). Alternatively, the device 110 may be configured to at least partially overlie the bowl surface 124 securing the device 110 and positioning the device 110 in a generally fixed position in relation to the liquid surface 120. In this manner, the device 110 may be secured in a stationary position while attenuating the noise and splash associated with a plumbing fixture 112.

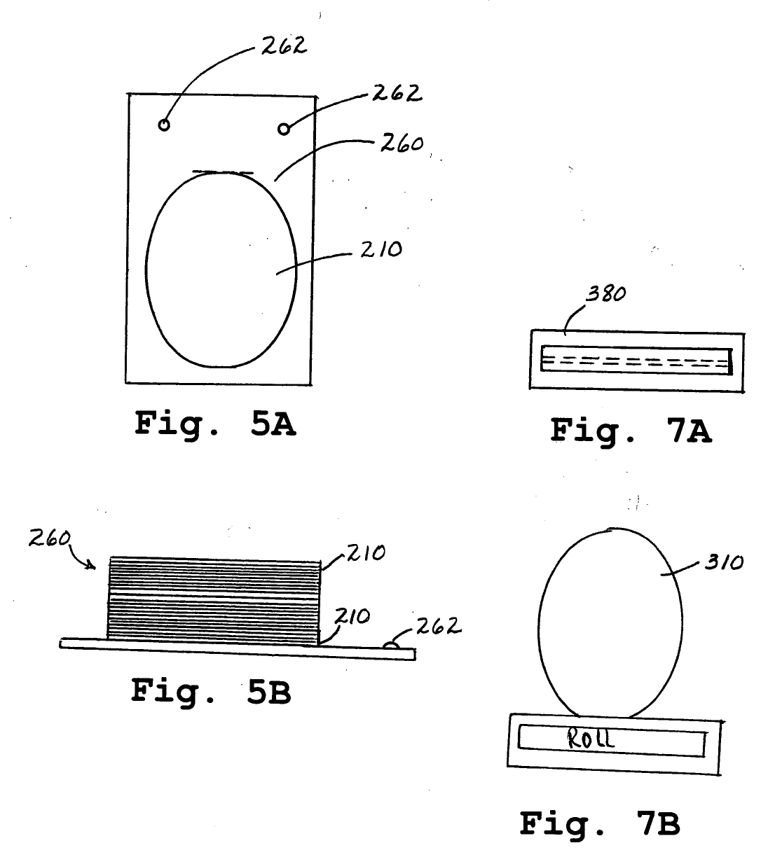

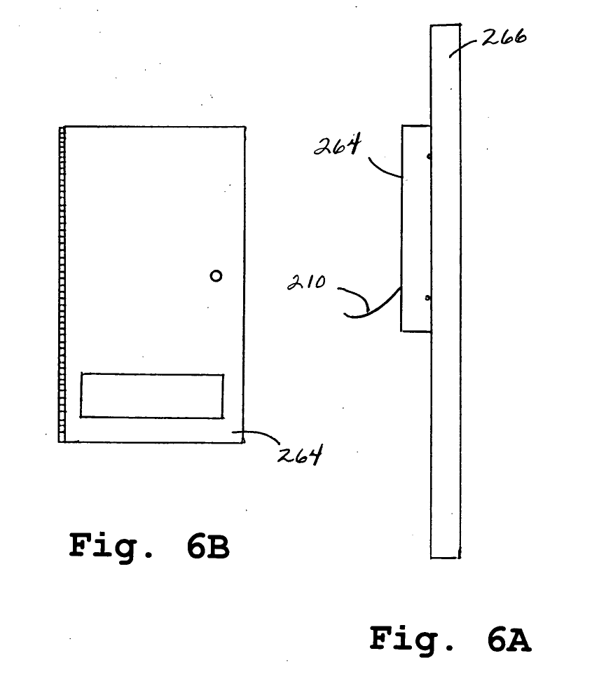

FIGS. 5A and 5B show another feature of the present invention in which the invention is packaged and dispensed in a replaceable pad 260 in which multiple devices 210, are stored and then dispensed. As a device 210 is lifted from the pad 260 another device 210 is positioned for removal at the next instance. Optionally the devices 210 may be perforated for easier removal from the pad 260. In the embodiment shown the pad 260 attaches to a dispenser (not shown) using at least one fastener 262. Although the fastener can be screws, rivets or other types of mechanical fasteners, the preferred method is a double sided adhesive fastener. Alternatively, the pad 260 may be configured as a portable convenient pad having plural devices 210 provided for transport by the user. Another alternative embodiment is shown in FIGS. 6A and 6B with the devices 210 being sequentially stored within a container 264 mechanically fastened to a wall 266, the plurality of devices 210 being adapted for individual removal from the container 264.

In another alternative embodiment as illustrated in FIGS. 7A and 7B a disposable box 380 is provide for storing plural devices 310 sequentially arranged for attenuating noise and splash associated with the use of the plumbing fixture.

III. Noise and Splash Attenuation Structure

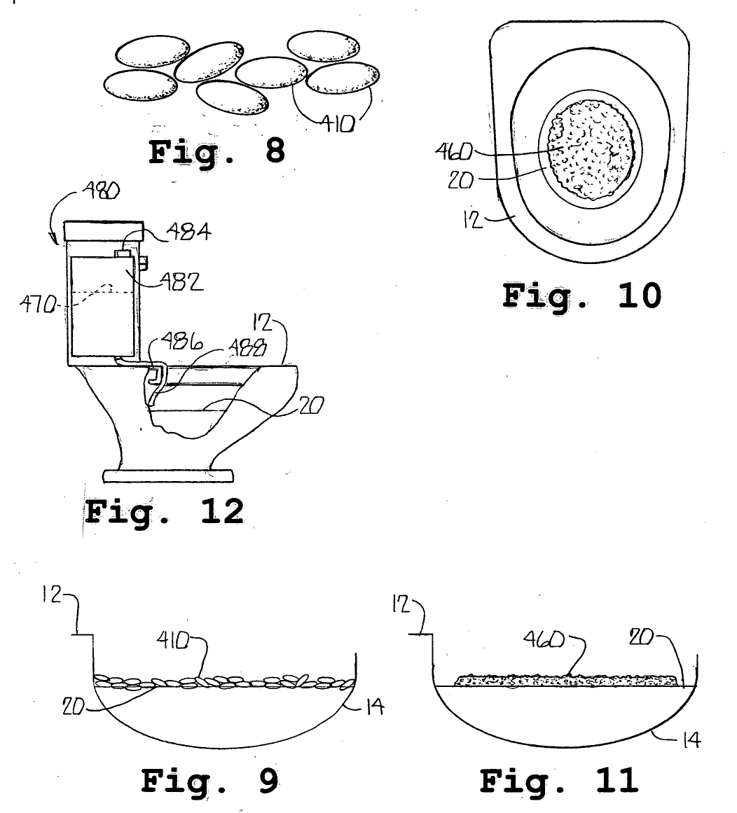

Alternatively, as illustrated in FIGS. 8-9, plural elongated structures 410 may be utilized in an alternative embodiment of the present invention to attenuate noise and splash. As illustrated in FIG. 9, the elongated structures 410 are received within the toilet fixture 12 overlying the liquid surface 20 contained within the bowl 14. As the falling liquid (not shown) is received within the toilet fixture 12, the elongated structures 410 absorb, deflect and transmit the falling liquid to the underlying liquid surface 20. The elongated structures 410 may be fabricated from a non-toxic, liquid absorbing material, such as a starch based biodegradable material like the type used for some commercially available bio-degradable loose fill packing fillers. The plural structures 410 present a transmission network for transmitting the falling liquid to the liquid surface 20. The elongated structures 410 may include but are not limited to pellets, capsules, cylinders, tubular, regular and irregular shaped structures.

The elongated structures 410 may be formed by pumping a liquid starch or sugar, diisocyanate, polyols and a catalyst into a mixing chamber (not shown). The mixed liquid being released from the mixing chamber and cured where the formed elongated structures 410 expand and dry. In operation, the falling liquid may be partially absorbed by the structures 410 or deflected towards the liquid surface 20. The absorption or deflection of the falling liquid reduces the momentum and emitted noise providing for a quieter and cleaner environment. Upon contact with the liquid surface 20 or falling liquid, the elongated structure begins to degrade into smaller sizes or may optionally be converted into simpler compounds like urea, making the degraded product suitable for treatment in waste water systems or for disposal in landfills or for use as a fertilizer.

IV. Noise and Splash Attenuation Agent

FIG. 10 illustrates an alternative embodiment of the present invention, a foam agent 460 for attenuating emitted noise and splash from the plumbing or toilet fixture 12. The foam agent 460 may be produced from a reaction with the liquid surface 20 of a carbonate, an organic acid combined with a surfactant in generally equal portions. When formed, the foam 460 generally covers the liquid surface 20 within the toilet fixture 12 and absorbs a portion of the energy from any falling liquid (not shown).

While many compounds are known to evolve a gas when reacted with water, an example of such is a mixture of citric acid with sodium bicarbonate, releasing carbon dioxide into the surfactant. When the gas, released during the reaction is introduced to the surfactant such as soap, a foam forms. The formed foam 460 generally covers the liquid surface 20 of the toilet fixture 12 which is generally between 16 to 400 square centimeters in a standard toilet fixture 12, the foam 460 forming a depth, generally between one-half to ten (10) centimeters from the liquid surface 20. In general, the range of foam produced will vary from between 500 and 700 cc in a standard toilet fixture 12. However, the amount produced in a urinal or other non-standard fixture will differ.

The foam agent is generally formed from biodegradable, primary chemical materials which are commonly and commercially available. In use, one example includes preselecting roughly equal parts of solid citric acid, solid detergent or surfactant and solid sodium bicarbonate, which are combined to form the foam agent which may be distributed into the plumbing fixture manually, or through an optional distribution system 480 as illustrated in FIG. 12.

In general, the distribution system 480 is configured to distribute an agent 470 from a vessel 482 to a liquid surface 20. As illustrated in FIG. 12, the optional distribution system 480 may include a dispenser (not shown) having a pump or a valve for selectively dispensing the mixture 470 to the toilet fixture 12 from the vessel 482 which receives and stores the foam agent mixture 470, also referred to herein as mixture or agent. As illustrated, the distribution system may also include an activation mechanism 484 like a switch, button or lever for selectively engaging the dispenser to dispense the stored agent 470 through the distribution system 480. In use, the distribution system 480 distributes the foam agent 470 from the vessel 482 to the liquid surface 20 through a tube 486 having a terminal end 488 positioned within the toilet fixture 12 above the liquid surface 20, the agent 470 being positioned to react with the liquid within the fixture 12 at the liquid surface 20.

When the agent 470 is introduced to the liquid surface 20 of the toilet fixture 12, contact between the liquid within the toilet fixture 12 and the agent 470 initiates the reaction between the acid and the carbonate. Generally, the acid is used to lower the pH of the liquid within the toilet fixture 12, while the surfactant in combination with the carbonate is used to form the foam 460. Once the pH of the liquid is lowered to around 6 or lower, the equilibrium of the carbonate in solution is shifted towards the production of gas according to the following equation:
NaHCO₃(aq.)+H⁺(aq.)→CO₂ (gas)+H₂O+Na⁺(aq.)

Liberated gas from the dissolution of the CO₂ may become entrapped in the surfactant, producing bubbles, forming the foam 460. Generally, the foam 460 absorbs a portion of the energy and momentum of the falling debris, reducing the noise and splash emitted at the point of impact between the falling debris and the underlying liquid surface 20. The foam 460 can also be modified using additional surfactant agents such as glycerine, various fragrances and coloring agents to provide different foam properties which enhance the foam 460 or enhance the dispersal of the foam 460 after use. Some properties which may be enhanced by utilizing different surfactants may include, the foam density, improving the foaming ability, the cost, hardness, sensitivity and mildness. Other foam properties which may be modified using additional modifying agents include the foam operational time, the speed of formation, the density of the foam, the stability of the foam to agitation.

During the reaction with the acid, the carbonate will release a non-reactive carbon dioxide gas. Examples of gas releasing carbonates include, but are not limited to, alkaline metal carbonate, sodium bicarbonate, sodium hydrogen carbonate, disodium carbonate, calcium carbonate, metal hydrogen carbonate or metal carbonate. Examples of solid acids which will facilitate the release of the gas may include but is not limited to, sodium hydrogen sulfite, sodium hydrogen carbonate, citric acid or sodium dihydrogen phosphate. In addition, the surfactant may be a number of different classifications of commercially available surfactants including anionic, cationic, amphoteric and neutral surfactants such as, but not limited to, sodium stearate, sodium dodecyl sulfate, cetalkonium chloride, lecithin, polidocanol or solid detergent.

After the reaction between the acid and carbonate and the release of the gas, the resultant is an ionic aqueous solution contained within the toilet fixture 12 which is inert and can be disposed down a plumbing system.

Additional surfactant modifying compounds such as coloring compounds like red, blue or green colorings and fragrances may be included in the noise and splash attenuation agent. The modifying compounds improve or modify the surfactant. By way of illustration only and not as a limitation, examples of modifying compounds include glycerin, methyl soyate and polycellulose. Examples of fragrances which may be used to deodorize or improve the fragrance of the area surrounding the toilet fixture 12 include limonene and pinene, but other known fragrances may be utilized in the present invention.

The noise and splash attenuating agent may be provided in a granular form with particles of between two and ten millimeters in diameter or alternatively, it may be prepared into a small compact structure like a tablet, capsule or pellet. Another optional method of packaging the agent, may be to seal a portion of the granules into a sealed packet for dispensing selectively into the toilet fixture 12, or the agent may be formed into a liquid or gel which is selectively distributed to the toilet fixture 12.

The agent 470 may be formed by providing a mixture of generally equal amounts of a surfactant, an alkaline metal carbonate and an organic acid, each being a dry powder, forming a foam 460 on the liquid surface 20 by reacting the mixture 470 with the liquid within the toilet fixture 12, receiving falling debris into the foam 460 and attenuating the noise and splash emitted from the falling debris at the liquid surface 20.

Alternatively, the foam agent 470 may be used in combination with the elongated starch based structure or the noise and splash attenuating device 10, the agent 470 being generally applied to the planar surface 22a opposite the liquid surface 20 allowing the foam 460 to form above the planar surface 22a, the liquid surface 20 transmitted through the planar surface 22a to the applied agent 470 for the foam forming reaction.

### EXAMPLES

In order to demonstrate the effectiveness of the technical teaching according to the invention, tests were carried out on the present invention. To this end, a tablet was formed measuring 4 cm in diameter and 1 cm in thickness, including approximately 6 g each of heat treated sodium bicarbonate, citric acid and approximately 9 g of a solid surfactant, prepared for testing in the desired concentrations. The tablet was transferred to standard toilet fixture containing a liquid having a pH of 8.8 at a temperature of 21° C. Once introduced into the fixture, the reaction lasted for 45 seconds and the final pH was 6.2. The amount of foam produced from this test was 620 cc.

An additional test was carried out using a granular composition including approximately 6 g each of heat treated sodium hydrogen carbonate, 6 g citric acid, 6 g citrus acids and 9 g Alconox® a concentrated, anionic detergent for manual and ultrasonic cleaning. Alconox® is commercially available at www.alconox.com, Alconox® being a registered trademark of Alconox, Inc. The granular composition was introduced into the toilet fixture containing a liquid having a pH of 8.8 at a temperature of 21° C. The duration of the reaction was 30 seconds and the final pH was 5.4. The amount of foam produced from this test was 570 cc. In both tests the foam formed as a result of the reaction was sufficient to attenuate any noise and splash emitted at the liquid surface.

It will be appreciated that various other configurations and embodiments may fall within the scope of the present invention. Moreover, the device 10 can be fabricated in various sizes and from a wide range of suitable materials, using various manufacturing and fabrication techniques. While certain forms of the present invention have been illustrated and described herein, it is not to be limited to the specific forms or arrangement of parts described and shown.

1. A noise and splash attenuating device adapted for use with a toilet fixture having a liquid surface contained within a bowl for receiving a falling liquid falling along a vertical axis at a zone of contact, said device comprising:
a sheet adapted for placement within the zone of contact,
a transmission network associated with the sheet for transmitting the falling liquid to said liquid surface through said sheet, and
an incident angle to said vertical axis presented by said sheet at an intersection of said falling liquid and said sheet whereby said falling liquid is received.

2. The device according to claim 1 wherein said sheet is oval.

3. The device according to claim 1 wherein said sheet is water permeable and biodegradable.

4. A noise and splash attenuating device adapted for use with a toilet fixture having a liquid surface contained within a bowl for receiving a falling liquid falling at a zone of contact, said device comprising:
a starch based biodegradable elongated structure adapted for placement within the zone of contact,
a transmission network associated with the structure for transmitting the falling liquid to said liquid surface through said filler.

5. The device according to claim 4 wherein the elongated structure is a plurality of extruded cellulous cylinders which deflect the falling liquid to the liquid surface.

6. A mixture in combination with a toilet fixture having a liquid with a surface for receiving a falling debris, the mixture including:
a surfactant,
an alkaline metal carbonate,
an organic acid, combined in generally equal portions,
a foam formed from the reaction of said mixture with the liquid, and
said foam covering substantially all of the surface and absorbing the energy of the falling debris incident to said liquid surface thereby attenuating noise and splash emitted therefrom.

7. The composition according to claim 6 wherein the volume of said foam formed from said foam is in the range of 16 square centimeters to 400 square centimeters having a depth in the range of ½ centimeter to 10 centimeters from the liquid surface.

8. The composition according to claim 6 wherein said surfactant is a member selected from the group consisting of an anionic, cationic, amphoteric and neutral surfactants.

9. The composition according to claim 6 wherein said surfactant is sodium stearate, sodium dodecyl sulfate, cetalkonium chloride, lecithin, polidocanol or solid detergent.

10. The composition according to claim 6 wherein said alkaline metal carbonate is heat treated sodium bicarbonate, heat treated sodium hydrogen carbonate, sodium hydrogen carbonate, disodium carbonate, calcium carbonate, metal hydrogen carbonate or metal carbonate.

11. The composition according to claim 6 wherein said organic acid is solid acid, sodium hydrogen sulfite, sodium hydrogen carbonate, citric acid or sodium dihydrogen phosphate.

12. The composition according to claim 6 wherein said surfactant is detergent, said alkaline metal carbonate is sodium bicarbonate and said organic acid is citric acid.

13. The composition according to claim 6 further comprising a modifying compound selected from the group consisting of glycerin, methyl soyate and polycellulose, wherein the modifying compound modifies the surfactant.

14. The composition according to claim 6 further comprising a fragrance compound selected from the group consisting of limonene and pinene.

15. The composition according to claim 6 wherein the mixture is contained in an extruded cellulous cylinder.

16. The composition according to claim 6 wherein said mixture is a granular compound having particles of at least 2 millimeters in diameter (up to 10 millimeters).

17. The composition according to claim 6 wherein said mixture is formed into tablets.

18. The composition according to claim 6 further comprising a sheet having a top and a bottom adapted for resting on the liquid surface, wherein said mixture is impregnated onto the top of the sheet, said bottom being located adjacent-to said liquid surface.

19. The composition according to claim 6 wherein said mixture is stored within a sealed packet for selectively dispensing into said toilet fixture.

20. The composition according to claim 6 wherein said mixture is formed into a liquid.

21. The composition according to claim 6 further comprising:
a dispenser for selectively dispensing the mixture to the toilet fixture,
a vessel for receiving and storing the mixture, and
a distribution system for distributing the mixture from the vessel to the liquid surface for forming foam.

22. A mixture of a surfactant, an alkaline metal carbonate and an organic acid in combination with a toilet fixture adapted for receiving a falling debris, the toilet fixture having a liquid surface contained within a bowl the combination comprising a foam formed from the reaction of the mixture with the liquid surface whereby said foam attenuates noise and splash emitted from the debris falling into the bowl.

23. A mixture in combination with a toilet fixture having a liquid for attenuating the noise and splash of falling debris, the mixture made by the steps of:
providing a surfactant, an alkaline metal carbonate and an organic acid wherein each are a dry powder,
forming a foam on the liquid surface within the toilet fixture by placement of the mixture therewithin,
receiving falling debris through said foam onto said liquid surface, and
attenuating noise and splash emitted from the falling debris.

24. The composition of claim 23 further including the step of receiving a falling liquid through said foam onto the liquid surface.
